(19) United States
(12) Patent Application Publication
(10) Pub. No.: US 2026/0221654 A1
(43) Pub. Date: Jul. 30, 2026

(54) ANTENNA, MOBILE COMMUNICATION BASE STATION AND USER DEVICE

(71) Applicant: Telefonaktiebolaget LM Ericsson (publ), Stockholm (SE)

(72) Inventors: Andreas Vollmer, Rosenheim (DE); Sertan Hasturkoglu, Rosenheim (DE)

(21) Appl. No.: 19/150,438

(22) PCT Filed: Feb. 8, 2023
(86) PCT No.: PCT/EP2023/053134

§ 371 Date: Jul. 23, 2025

(51) Int. Cl. H01Q 5/378; H01P 1/00; H01Q 1/24; H01Q 19/10; H01Q 21/06

(52) U.S. Cl. CPC H01Q 5/378; H01Q 1/246; H01Q 19/108; H01Q 21/062; H01P 1/00

(57) ABSTRACT

An antenna has a reflector, a first radiator having a radiator head and at least one support, as well as a second radiator. The radiator head of the first radiator comprises at least two radiation structures forming at least one dipole. The first radiator comprises a balun structure and a shifting structure, wherein the balun structure comprises a balun ground plane at the support, a signal line at the support, and a connecting line extending from the support to the radiation structures of the radiator head. The shifting structure comprises a head portion located on the radiator head and an inductive line electrically connecting the head portion to the balun ground plane. Further, a mobile communication base station and a user device are shown.

### TECHNICAL FIELD

The invention relates to an antenna, a mobile communication base station as well as to a user device.

### BACKGROUND

Multiband antennas are known in the art. In such antennas, a first array of first radiators designed for a first frequency band are interleaved with a second array of second radiators designed for a second frequency band. It is desirable that the radiators of the arrays have no influence on each other.

Usually, radiators designed as half wavelength dipoles are used. However, the first natural resonance does occur at a fourth of the wavelength of the design frequency, i.e. the average frequency of the respective frequency band. This means that a common mode resonance of a low-mid band radiator designed for the frequency band between 1.4 GHz and 2.7 GHz lies fully within the frequency range of a low band radiator designed for the frequency band of 700 to 960 MHz. The resonances can occur over the dipoles but also including the balun structure as a resonating element. Quarter wavelength resonances require a typically a shortened and an open end of the resonating line structure. These resonances are called common mode resonances.

Balun structures that shift the common mode resonance frequency to frequencies outside the lower frequency band are known, for example from U.S. Pat. No. 9,698,486 B2 and US 2021/0328365 A1.

However, the structures for shifting the common mode resonance known in the art need a lot of space on the support or on the reflector to which the support is mounted or have a small bandwidth.

### SUMMARY

It is thus an object of the invention to provide an antenna with a shifted common mode resonance frequency that is small in size and easy to manufacture.

For this purpose, in an embodiment, an antenna, in particular for a mobile communication base station, is provided. The antenna comprises a reflector, a first radiator having a radiator head and at least one support, as well as a second radiator. The second radiator is mounted to the reflector, and the radiator head of the first radiator comprises at least two radiation structures forming at least one dipole. The support is mounted to the reflector and supports the radiator head above the reflector. The first radiator further comprises a balun structure and a shifting structure, wherein the balun structure comprises a balun ground plane at the support, a signal line at the support, and a connecting line extending from the support to the radiation structures of the radiator head. The shifting structure comprises a head portion located on the radiator head and an inductive line electrically connecting the head portion to the balun ground plane.

By providing a shifting structure with a head portion located on the radiator head, the common mode frequency is shifted effectively while only little space is needed on the support.

The first radiator is configured to emit and receive electromagnetic radiation in a first frequency band. For example, the first frequency band lies above 1.0 GHz, in particular the first frequency band is 1.4 GHz to 2.7 GHz.

The second radiator is configured to emit and receive electromagnetic radiation in a second frequency band, different from the first frequency band. For example, the second frequency band lies below 1.0 GHz, in particular the second frequency band may be 617 MHz to 960 MHz.

For example, the inductive line has a characteristic impedance higher than the impedance of a grounding balun structure. The impedance of the inductive line is, for example, greater than 75 Ohms.

The balun structure is in particular configured to balance the signals to the at least one dipole. For example, the balun structure forms a Marchand balun.

The shifting structure is in particular configured for shifting a common mode resonance.

In particular, the head portion of the shifting structure is separate from the radiation structure.

In an embodiment, the balun ground plane comprises two separate balun ground portions and two connecting lines and the shifting structure comprises two inductive lines, wherein each radiation structure is associated with one of the connecting lines, one of the inductive lines and one of the balun ground portions, in particular wherein each radiation structure is electrically coupled to the associated connecting line, the associated connecting line being electrically coupled to the associated balun ground portion, providing a symmetric shift structure further increasing signal quality.

The signal line may be capacitively coupled to both balun ground portions.

In an aspect, the shifting structure comprises a plurality of head portions, in particular as many head portions as the number of the radiating structures of the first radiator, wherein each of the head portions is associated with one of the radiating structures, providing a very reliable common mode shift.

For further improved signal quality, the connecting line may comprise a patch portion capacitively coupled to the balun ground plane, in particular the associated balun ground portion.

The patch portion may have a rectangular shape, with lengths of its sides within +−30% of one another.

For further simplifying manufacture, the inductive line may be electrically connected, in particular galvanically connected or capacitively coupled to the balun ground plane, in particular the associated balun ground portion, and/or galvanically coupled to the head portion of the shifting structure.

In an aspect, the inductive line comprises an inductive portion, in particular wherein the inductive line comprises parallel traces forming the inductive portion. This way, the inductivity provided by the inductive portion can be tuned easily by changing the length and amount of parallel traces.

For example, the parallel traces are part of a meander shape.

For further simplifying the design or reducing the space needed on the support, the balun structure may be located fully on the support or in part on the support and in part on the reflector.

In an embodiment, the support comprises a support carrier being a dielectric, in particular a foil or a printed circuit board or thermoplastic part, the support carrier having two surfaces, wherein the balun structure and the shifting structure are applied to the surfaces of the support carrier, in particular as metallizations or metal sheets. This way, a reliable and cost efficient way of manufacturing the support is provided.

For further improved signal characteristics, the two surfaces may be a ground surface and a signal surface, wherein the balun ground plane may be provided on the ground surface, the connecting line of the balun structure may be provided on the signal surface, and/or the inductive line of the shifting structure may be provided on the ground surface.

In particular, the ground surface and the signal surface are opposite surfaces, e.g. surfaces of the same layer of a material of the carrier.

The balun ground plane is, for example, located at least partially on the ground surface and/or the signal line is located at least partially on the signal surface.

In an aspect, the connecting line, in particular the patch portion, and the balun ground plane overlap in a projection perpendicular to the carrier, providing a well defined capacitive coupling.

In an embodiment, the radiator head comprises a head carrier being a dielectric, in particular a foil or a printed circuit board or thermoplastic part, the head carrier having two surfaces, wherein the radiation structures and the head portion of the shifting structure are applied to the surfaces of the head carrier, in particular as metallizations or metal sheets. This way, a reliable and cost efficient way of manufacturing the carrier is provided.

The support carrier and/or the head carrier may be multilayered.

It is also conceivable that at least one metallization is realized as sheet metal part and the support carrier and/or the head carrier may be a dielectric, in particular a thermoplastic part, adapted to fixate one or more sheet metal parts.

The radiation structures and the head portion may be located on the same surface, further reducing the space needed on carriers of the radiator.

The radiation structures and the head portion may be located on different ones of the surfaces of the head carrier, in particular wherein the radiation structures are located on the top surface of the surfaces and the head portion is located on the bottom surface of the surfaces or vice versa, further increasing signal quality.

In an embodiment, in a vertical projection, the head portion and the radiation structures overlap, in particular fully, providing an effective mode shift. In order to save space, the radiation structures may encircle a respective associated one of the head portion, in particular fully.

In an aspect, at least one part of the head portion is manufactured as a single piece with the inductive line and/or the balun ground portion as one bended sheet metal part and/or at least one part of the radiation structures is manufactured as a single piece with the connecting line and/or the patch portion as one bended sheet metal part. This way, manufacturing costs are further decreased.

For a very efficient shift of the common mode, the head portion may be a patch, in particular its largest diameter being at least 1/10, in particular at least ⅛, more particularly at least ⅙, more particularly at least ⅕, more particularly at least ¼, even more particularly at least ⅓ and/or its largest side having a length of 1/10, in particular at least ⅛, more particularly at least ⅙, more particularly at least ⅕, more particularly at least ¼, even more particularly at least ⅓ of a wavelength of an average frequency of a first frequency band; and/or the head portion may form a frequency selective surface.

In case of a plurality of head portion, each head portion may be a patch.

In an embodiment, the radiator comprises four radiation structures on the radiator head forming two dipoles and two supports, wherein each support is associated with one of the dipoles, in particular wherein the supports are arranged perpendicular to one another. This way, a dual polarized radiator is provided.

For example, four head portions are provided, each one associated with one of the radiation structures.

In an aspect, the antenna comprises a plurality of first radiators forming a first array and/or a plurality of second radiators forming a second array, providing a multiband array antenna. It is also conceivable that the antenna comprises a plurality of third radiators forming a third array.

For the above mentioned purpose, in an embodiment, further a mobile communication base station is provided, the base station having at least one antenna as described above.

Further, for the above mentioned purpose, in an embodiment, a user device for mobile communication is provided having at least one antenna as described above.

The features and advantages described with respect to the antenna also apply to the base station and/or the user device and vice versa.

### BRIEF DESCRIPTION OF THE DRAWINGS

Further features and advantages will be apparent from the following description as well as the accompanying drawings, to which reference is made. In the drawings:

FIG. 1 shows a mobile communication base station according to an embodiment of the invention with an antenna according to an embodiment of the invention and a user device according to an embodiment of the invention with an antenna according to an embodiment of the invention,

FIG. 2 shows an enlarged view of one second radiator, four first radiators and 16 third radiators of the antenna according to FIG. 1,

FIG. 3 shows an enlarged view of one of the first radiators of FIG. 2,

FIGS. 4, 5 show a front view and a back view, respectively, of the support of the radiator of FIG. 3,

FIGS. 6, 7 show a perspective view at the top surface and at the bottom surface, respectively, of the radiator head of the radiator of FIG. 3,

FIG. 8 shows a schematic side view the radiator of FIG. 3,

FIG. 9 shows a schematic side view of a radiator of an antenna according to a second embodiment of the invention, and

FIG. 10 shows a perspective view at the top of part of the radiator of FIG. 9.

### DETAILED DESCRIPTION

FIG. 1 shows an embodiment of a mobile communication base station 10 and an embodiment of a user device 12.

The mobile communication base station 10 has a plurality of antennas 14 for providing speech and data connections to user devices. Mobile communication base stations 10 are also referred to as mobile communication cell sites.

The mobile communication base station 10 may be an access network node of a radio access network of a telecommunication network, or any other similar 3rd Generation Partnership Project (3GPP) access nodes or non-3GPP access points.

Moreover, as will be appreciated by those of skill in the art, an access a network node is not necessarily limited to an implementation in which a radio portion and a baseband portion are supplied and integrated by a single vendor. Thus, it will be understood that network nodes include disaggregated implementations or portions thereof.

For example, in some embodiments, the mobile communication base station 10 is an Open-RAN (ORAN) network node. An ORAN network node is a node in the telecommunication network that supports an ORAN specification (e.g., a specification published by the O-RAN Alliance, or any similar organization) and may operate alone or together with other nodes to implement one or more functionalities of any node in the telecommunication network, including one or more network nodes and/or core network nodes.

Examples of an ORAN network node include an open radio unit (O-RU), an open distributed unit (O-DU), and an open central unit (O-CU).

The antenna 14 of the mobile communication base station 10 is a multiband antenna to provide speech and data connections in various frequency bands.

The user device 12 has an antenna 16 and may be a mobile phone, a laptop computer, a customer premises equipment (CPE) or the like. The antenna 16 of the user device 12 is also a multiband antenna allowing a speech and/or data connection to the mobile communication base station 10 and/or to a communication satellite.

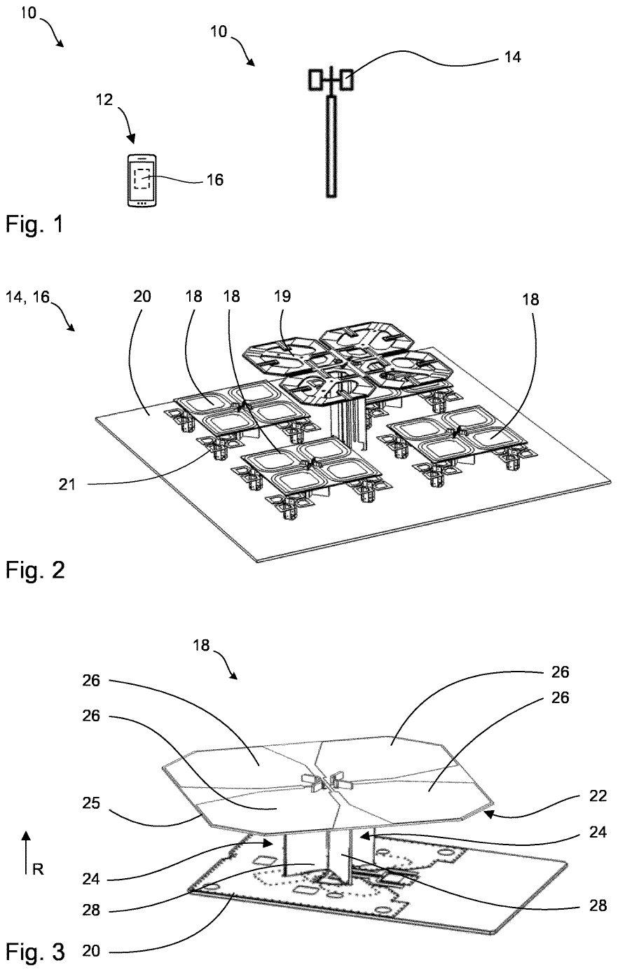

As shown in FIG. 2, exemplarily depicting radiators for a mobile communication base station 10, both antennas 14, 16 have a plurality of first electromagnetic radiators 18 and a plurality of second radiators 19, even though only one is shown in FIG. 2.

The first radiators 18 (called first radiators 18 only for differentiation) form a first array designed for a first frequency band. Thus, the first radiators 18 are designed to transmit and receive electromagnetic waves in the first frequency band.

Likewise, the second radiators 19 form a second array for a second frequency band. Thus, the second radiators 19 are designed to transmit and receive electromagnetic waves in a second frequency band.

In the embodiment of FIG. 2, the antenna 14, 16 comprises even third radiators 21 forming a third array for a third frequency band. Thus, the third radiators 21 are designed to transmit and receive electromagnetic waves in a third frequency band.

The first radiators 18, in particular the first array, and the second radiators, in particular the second array, are interleaved with one another.

In the shown embodiment, the third array is also interleaved with the first and second array.

The first frequency band lies above the second frequency band, in particular fully, i.e. not overlapping with the second frequency band.

The third frequency band lies above the first frequency band, in particular fully, i.e. not overlapping with the first frequency band.

For example, the first frequency band lies above 1.0 GHz, in particular the first frequency band is 1.4 GHz to 2.7 GHz.

For example, the second frequency band lies below 1.0 GHz, in particular the second frequency band may be 617 MHz to 960 MHz.

The first radiators 18, the second radiators 19 and the third radiators 21 are mounted on a reflector 20, serving as the common reflector for all types of radiators 18, 19, 21.

FIG. 3 shows one of first radiators 18 mounted to the reflector 20.

Directional terms like “up”, “down”, “above”, “vertical”, etc. are to be understood with respect to the radiation direction R of the radiator (also referred to as “vertical”). “Sideways” or “horizontal” is to be understood as a direction perpendicular to the radiation direction R.

The radiator 18 comprises a radiator head 22 and two supports 24.

The radiator head 22 comprises a head carrier 25 and four radiation structures 26 applied to the head carrier 25.

The head carrier 25 extends parallel to the reflector 20.

The radiation structures 26 are arranged in a 2×2 grid, wherein diagonally opposite radiation structures 26 form one dipole.

For example, the radiator head 22 is a dual-polarized dipole, in particular with one +45-degree and one −45-degree single-polarized dipole. Each single-polarized dipole comprises two dipole arms.

The radiator head 22, more precisely the head carrier 25, is mounted above the reflector 20 by means of the supports 24.

Each support 24 comprises a mechanical support carrier 28 for mechanically supporting the radiator head 22 as well as a balun structure 30 and a shifting structure 32. The balun structure 30 and the shifting structure 32 are not shown in FIG. 3 for simplicity.

The support carriers 28 of the supports 24 both extend perpendicular from the reflector 20. With respect to each other, the support carriers 28 are arranged perpendicular to one another and/or cross one another.

The support carrier 28 may be a substrate of a dielectric material. For example, the substrate is a printed circuit board.

It is also conceivable that the support carrier 28 is one or more foils carrying the balun structure 30 and the shifting structure 32.

In the shown embodiment, the support carrier 28 has two surfaces, namely a signal surface S and a ground surface G.

It is conceivable that the support carrier 28 is multilayered, e.g. a multilayered substrate. In this case, the support carrier 28 comprises more than two surfaces. In multilayered substrates, inner surfaces may be referred to as layers.

The balun structure 30 and the shifting structure 32 may be metallizations deposited on the respective surface of the support carrier 28 using deposition techniques as known in the art.

It is conceivable that the support carrier 28 is a thermoplastic part supporting a metal sheet forming the balun structure 30 and/or the shifting structure 32.

In the same way, the radiator head 22 comprises the head carrier 25 with the radiation structures 26 applied to the surface of it.

The head carrier 25 may be a substrate of a dielectric material. For example, the substrate is a printed circuit board.

It is also conceivable that the head carrier 25 is one or more foils carrying parts of the balun structure 30 and the radiation structures 26.

In the shown embodiment, the head carrier 25 has two surfaces, namely a top surface T and a bottom surface B.

It is conceivable that the head carrier 25 is multilayered, e.g. a multilayered substrate. In this case, the head carrier 25 comprises more than two surfaces. In multilayered substrates, inner surfaces may be referred to as layers.

The parts of the balun structure 30 and the radiation structures 26 may be metallizations deposited on the respective surface of the head carrier 25 using deposition techniques as known in the art.

It is conceivable that the head carrier 25 is a thermoplastic part supporting a metal sheet forming the balun structure 30 and/or the radiation structures 26.

The head carrier 25 is mounted on the support carriers 28 and extends perpendicular to the support carriers 28.

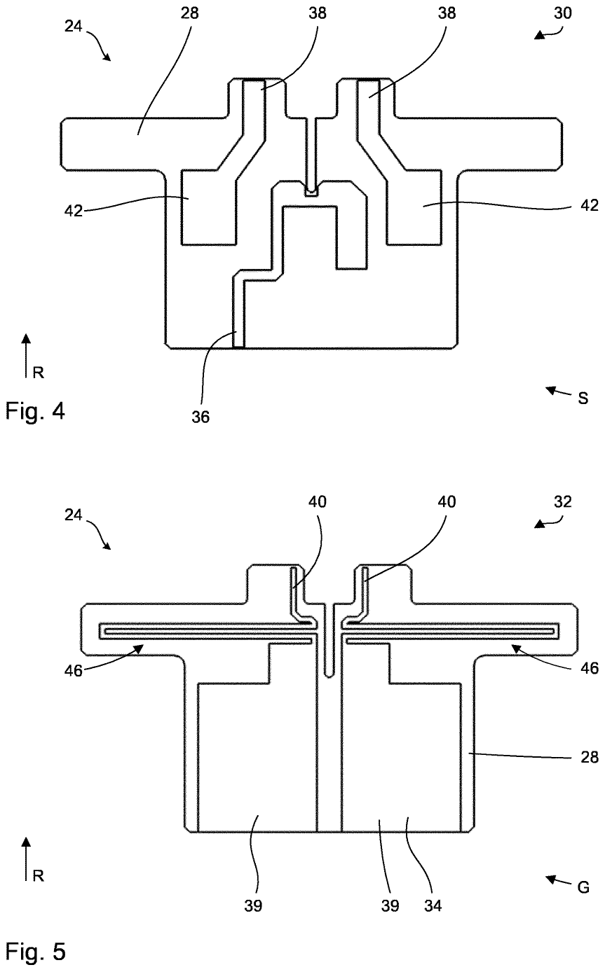

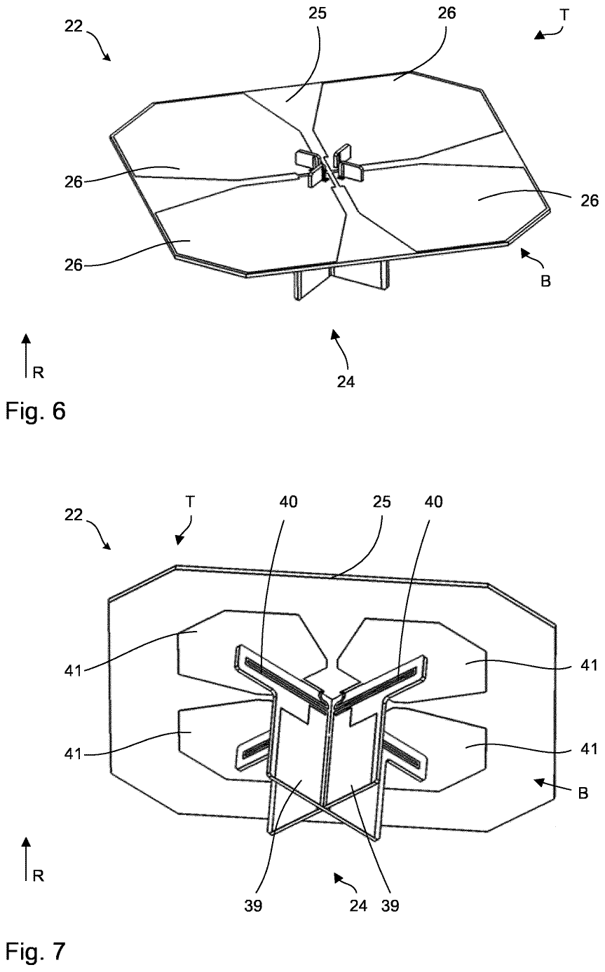

FIGS. 4 and 5 shows one of the supports 24 in a front view, i.e. onto the signal surface S, and in a back view, i.e. onto the ground surface G, respectively.

In particular, the balun structure 30 and the shifting structure 32 of the supports 24 are identical so that only one support 24 is discussed in the following.

The balun structure 30 and the shifting structure 32 are electrically connected to the radiation structure 26 of one of the dipoles.

The balun structure 30 comprises a balun ground plane 34, a signal line 36 and two connecting lines 38.

The balun structure 30 forms a Marchand balun as known in the art.

The balun ground plane 34 and the signal line 36 are arranged on opposite sides of the support carrier 28. For example, the signal line 36 is located on the signal surface S and the balun ground plane 34 is located on the ground surface G.

The balun ground plane 34 comprises two balun ground portions 39 arranged side by side, each one associated with a different one of the radiation structures 26 of the corresponding dipole.

The balun ground portions 39 are separated by a vertical gap between them and each of the ground portions 39 extends from the lower end of the support 24 upwards.

In the assembled state, both balun ground portions 39 are electrically connected to the reflector 20, more precisely galvanically or capacitively coupled to a reflector ground plane of the reflector 20.

The signal line 36 extends from the lower end of the support 24 in the region of one of the balun ground portions 39 upwards, and then partly sideways across the gap into the region of the other balun ground portion 39.

It is also conceivable that parts of the balun ground plane 34, i.e. parts of the balun ground portions 39, and/or parts of the signal line 36 are arranged on the reflector 20.

The shifting structure 32 comprises two inductive lines 40 and two head portions 41.

Each of the radiation structures 26 of the corresponding dipole is associated with one of the head portions 41, one of the connecting lines 38, one of the inductive lines 40 and one of the balun ground portions 39. Thus, the associated head portion 41, the associated balun ground portion 39, the associated connecting line 38 and the associated inductive line 40 are electrically connected to one another and to the respective radiation structure 26.

The head portions 41, the connecting lines 38 and/or the inductive lines 40 are in particular identical, but mirrored. In the following, it is referred to only one set of a radiation structure 26 and the associated head portion 41, the associated connecting line 38, the associated inductive line 40 and the associated balun ground portion 39.

The connecting line 38 of the balun structure 30 is located on the signal surface S of the support carrier 28 and extends from the balun structure 30 upwards to the radiator head 22.

The connecting line 38 is electrically, in particular galvanically coupled to the associated radiation structure 26 of the associated dipole. The connecting line 38 may be soldered to the associated radiation structure 26 at the top surface T of the head carrier 25.

The connecting line 38 comprises a patch portion 42 constituting the lower end of the connecting line 38.

The patch portion 42 has a rectangular shape, in particular a square shape. For example, the lengths of the sides of the rectangular shape do not differ from one another by more than 30%.

From the patch portion 42 upwards, the remaining connecting line 38 extends in a line-shaped fashion, wherein the width of the line is broader than the width of the signal line 36 of the balun structure 30.

It is conceivable that parts of the connecting line 38 may be located on the radiator head 22.

The patch portion 42 is located in the region of the balun ground portion 39 at least partly. Thus, as can be seen in FIGS. 4 and 5, the patch portion 42 and the associated balun ground portion 39 overlap with one another in a projection perpendicular to the support carrier 28.

Thus, the patch portion 42 is capacitively coupled to the associated balun ground portion 39.

Further, at least a portion of the signal line 36 of the balun structure 30, in particular the portion extending sideways, is located between the patch portions 42.

As seen in FIG. 5, the inductive line 40 of the shifting structure is located at the ground surface G, i.e. on the opposite surface than the associated connecting line 38.

The inductive line 40 extends with its first end from the associated balun ground portion 39 upwards.

Starting from the first end, the inductive line 40 has an inductive portion 46 and then extends upwards to the radiator head 22 where it electrically, in particular galvanically couples to the associated head portion 41 at its second end.

The second end is, for example, at the same level in the radiation direction R as the end of the connecting line 38.

In the shown embodiment, the inductive line 40 extend fully on the support 24.

In the inductive portion 46, the trace of the inductive line 40 extends in meanders. Thus, in the inductive portion 46 several, but at least two parallel traces of the inductive line 40 are present.

Due to the parallel traces, the inductive portion 46 provides an inductivity.

Turning now to the radiator head 22, as seen in FIGS. 6 and 7 showing a perspective view of the radiator head 22 onto the top surface T and the bottom surface B, respectively. In the shown embodiment, four radiation structures 26 are provided on the top surface T of the head carrier 25.

The radiation structures 26 are provided as patches extending from the center of the radiator head 22 outwards.

Other shapes and geometries of the radiation structures 26 are also conceivable and well known in the art.

In the shown embodiment, four head portions 41 of the shifting structure 32 are provided at the bottom surface B, each one associated with one of the radiation structures 26.

Thus, the shifting structure 32 extends both on the support 24 as well as on the radiator head 22. Further, in the first embodiment, the radiation structures 26 and the head portion 41 of the shifting structure 32 are located on opposite surfaces of the head carrier 25.

Each of the head portions 41 is formed as a patch. Each patch having a largest diameter of at least 1/10, in particular at least ⅛, more particularly at least ⅙, more particularly at least ⅕, more particularly at least ¼, even more particularly at least ⅓ and/or its largest side of at least 1/10, in particular at least ⅛, more particularly at least ⅙, more particularly at least ⅕, more particularly at least ¼, even more particularly at least ⅓ of a wavelength of the average frequency of the first frequency band.

The head portions 41 are located below their associated radiation structures 26, i.e. in a projection in the vertical direction (the radiation direction R) the radiation structures 26 overlap with their respective head portion 41. In particular, the head portion 41 is fully overlapped by the associated radiation structure 26. The head portion 41 is therefore coupled to the radiation structure 26 by means of the overlapping area.

It is conceivable that at least one part of the head portion 41 is manufactured as one piece with the inductive line 40 and/or the balun ground portion 39 as a single bended sheet metal part. Further, at least one part of the radiation structures 26 may be manufactured as one piece with the connecting line 38 and/or the patch portion 42 as a single bended sheet metal part. One or both of the bended sheet metal parts may be held by the head carrier 25, the support carrier 28 or the head carrier 25 and the support carrier 28 at the same time.

During operation, a signal is fed to the signal line 36. The signal is balanced by the balun structure 30 and fed to the radiation structures 26 for generating a respective electromagnetic wave.

The balun structure 30 provides the necessary balancing for converting the unbalanced signal of the signal line 36 to a balanced signal needed by the radiation structures 26.

Further, the shifting structure 32 shifts the common mode resonance of the first radiators 18 to a frequency outside of the second frequency band. In other words, the first natural resonance (i.e. the resonance without a shifting structure) occurring at ¼ of the wavelength of the average frequency of the first frequency band is moved out of the second frequency band, thus improving signal quality.

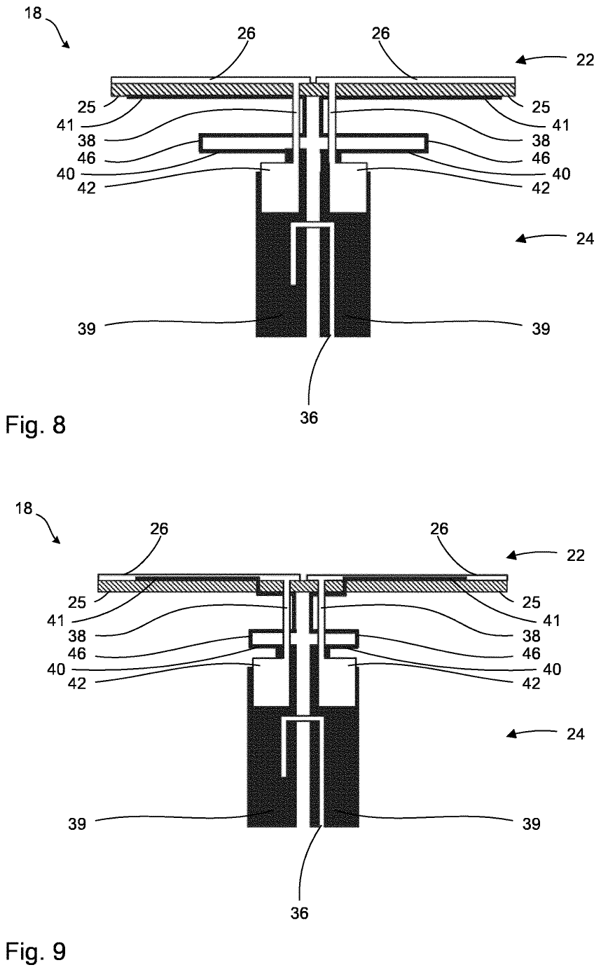

FIG. 8 shows a schematic side view representing the radiator 18, namely one dipole and one support 24 of the first radiator 18.

As can be seen from FIG. 8, the balun structure 30 is connected to the radiation structure 26 by the connecting line 38 mainly providing a capacitance.

At the same time, the inductive line 40 provides an inductivity and the head portion 41 provide a capacitance.

The shifting structure 32 is symmetrical while, at the same time, providing a high degree of freedom for tuning and shifting the common mode resonance. Further, the shifting structure 32 is very compact and simple to manufacture.

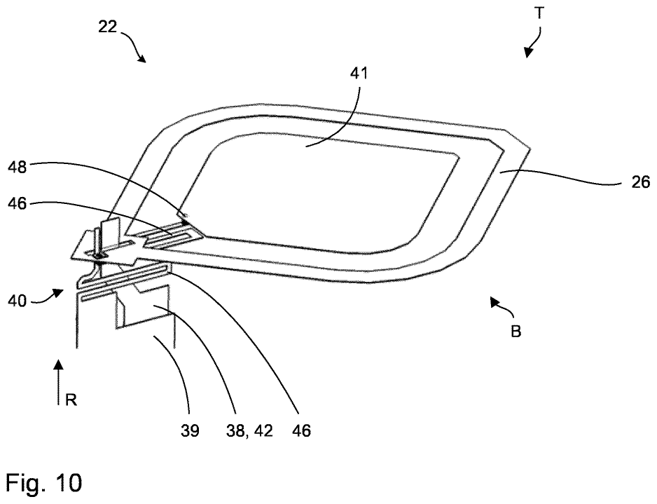

FIGS. 9 and 10 show parts of a first radiator 18 of an antenna 14, 16 of a second embodiment of the invention. The second embodiment of the invention corresponds substantially to the first embodiment so that only the differences are discussed in the following. Same and functionally the same components are labeled with the same reference signs.

FIG. 9 shows a schematic similar to that of FIG. 8 in which the differences between the first and second embodiment become apparent.

Firstly, the radiation structures 26 and the head portions 41 of the shifting structure 32 are both located on the same surface of the head carrier 25, in the shown embodiment the top surface T.

To this end, the connecting line 38 extends also onto the radiator head 22, for example at the other surface than the radiation structure 26, in the shown embodiment the bottom surface B.

The connecting line 38 is then galvanically connected to the respective head portion 41 by a via 48 (FIG. 10) through the head carrier 25.

A capacitive coupling to the head portion 41 is also conceivable.

Further, in the second embodiment, the inductive portion 46 is smaller than the inductive portion 46 in the first embodiment, meaning that the length of parallel traces is reduced. This reduces the inductivity of the inductive lines 40.

FIG. 10 shows one of the dipoles of the first radiator 18 in a perspective view onto the top, wherein the head carrier 25 and the support carrier 28 are not shown to illustrate the spatial relation of the radiation structures 26 to the components of the balun structure 30 and the shifting structure 32.

In the second embodiment, the radiation structures 26 form a loop encircling an area. Within this area, the head portion 41 is located. The head portion 41 is a patch, similar to the first embodiment.

Further, as can be seen in FIG. 10, the inductive line 40 comprises a second inductive portion 46 on the radiator head 22, i.e. a portion with parallel traces.

The features of the shown embodiments may be combined freely with one another. In particular, the head portion 41 of the shifting structure 32 of the second embodiment may as well be located on the bottom surface B.

It is also conceivable that the head portion 41 of the shifting structure 32 comprises a regular pattern of elements forming a frequency selective surface. The frequency selective surface may be chosen such that it increases, for example, the transparency of the radiator head 22 for electromagnetic waves in the third frequency band.

In the foregoing detailed description, an antenna and a radiator for a mobile communication base station have been discussed. A radiator for an antenna of a user device may be structurally different from said radiator for a mobile communication base station, e.g. the radiator structures may be designed and scaled for much higher frequency bands, but the radiators for an antenna of a user device may still comprise the design principles of the invention as discussed above with respect the antenna and the radiator for a mobile communication base station.

1. An antenna, in particular for a mobile communication base station, comprising a reflector, a first radiator having a radiator head and at least one support, as well as a second radiator,
wherein the second radiator is mounted to the reflector,
wherein the radiator head of the first radiator comprises at least two radiation structures forming at least one dipole,
the support is mounted to the reflector and supports the radiator head above the reflector,
wherein the first radiator comprises a balun structure and a shifting structure,
wherein the balun structure comprises a balun ground plane at the support, a signal line at the support, and a connecting line extending from the support to the radiation structures of the radiator head, and
wherein the shifting structure comprises a head portion located on the radiator head and an inductive line electrically connecting the head portion to the balun ground plane.

2. The antenna according to claim 1, wherein the balun ground plane comprises two separate balun ground portions and two connecting lines and the shifting structure comprises two inductive lines, wherein each radiation structure is associated with one of the connecting lines, one of the inductive lines and one of the balun ground portions, in particular wherein each radiation structure is electrically coupled to the associated connecting line, the associated connecting line being electrically coupled to the associated balun ground portion.

3. The antenna according to claim 1, wherein the shifting structures comprises a plurality of head portions, in particular as many head portions as the number of the radiation structures of the first radiator, wherein each of the head portions is associated with one of the radiation structures.

4. The antenna according to claim 1, wherein the connecting line comprises a patch portion capacitively coupled to the balun ground plane, in particular the associated balun ground portion.

5. The antenna according to claim 1, wherein the inductive line is electrically connected, in particular galvanically connected or capacitively coupled, to the balun ground plane, in particular the associated balun ground portion, and/or galvanically coupled to the head portion of the shifting structure.

6. The antenna according to claim 1, wherein the inductive line comprises an inductive portion, in particular wherein the inductive line comprises parallel traces forming the inductive portion.

7. The antenna according to claim 1, wherein the balun structure is located fully on the support or in part on the support and in part on the reflector.

8. The antenna according to claim 1, wherein the support comprises a support carrier being a dielectric, in particular a foil or a printed circuit board or thermoplastic part, the support carrier having two surfaces, wherein the balun structure and the shifting structure are applied to the surfaces of the support carrier, in particular as metallizations or metal sheets.

9. The antenna according to claim 8, wherein the two surfaces are a ground surface and a signal surface, wherein the balun ground plane is provided on the ground surface, the connecting line of the balun structure is provided on the signal surface, and/or the inductive line of the shifting structure is provided on the ground surface.

10. The antenna according to claim 8, wherein the connecting line, in particular the patch portion, and the balun ground plane overlap in a projection perpendicular to the support carrier.

11. The antenna according to claim 1, wherein the radiator head comprises a head carrier being a dielectric, in particular a foil or a printed circuit board or thermoplastic part, the head carrier having two surfaces, wherein the radiation structures and the head portion of the shifting structure are applied to the surfaces of the head carrier, in particular as metallizations or metal sheets.

12. The antenna according to claim 11, wherein the radiation structures and the head portion are located on the same surface or on different ones of the surfaces of the head carrier, in particular wherein the radiation structures are located on a top surface of the surfaces and the head portion is located on a bottom surface of the surfaces or vice versa.

13. The antenna according to claim 1, wherein at least one part of the head portion is manufactured as one piece with the inductive line and/or the balun ground portion as one bended sheet metal part and/or at least one part of the radiation structures is manufactured as one piece with the connecting line and/or the patch portion as one bended sheet metal part.

14. The antenna according to claim 1, wherein, in a vertical projection, the head portion and the radiation structures overlap, in particular fully, or that the radiation structures encircle a respective associated one of the head portion, in particular fully.

15. The antenna according to claim 1, wherein the head portion is a patch, in particular its largest diameter being at least 1/10, in particular at least ⅛, more particularly at least ⅙, more particularly at least ⅕, more particularly at least ¼, even more particularly at least ⅓ and/or its largest side having a length of 1/10, in particular at least ⅛, more particularly at least ⅙, more particularly at least ⅕, more particularly at least ¼, even more particularly at least ⅓ of a wavelength of an average frequency of a first frequency band; and/or that the head portion forms a frequency selective surface.

16. The antenna according to claim 1, wherein the radiator comprises four radiation structures on the radiator head forming two dipoles, and two supports, wherein each support is associated with one of the dipoles, in particular wherein the supports are arranged perpendicular to one another.

17. The antenna according to claim 1, wherein the antenna comprises a plurality of first radiators forming a first array and/or a plurality of second radiators forming a second array.

18. A mobile communication base station comprising at least one antenna, wherein an antenna of the at least one antenna comprises a reflector, a first radiator having a radiator head, and at least one support, as well as a second radiator,
wherein the second radiator is mounted to the reflector,
wherein the radiator head of the first radiator comprises at least two radiation structures forming at least one dipole,
the support is mounted to the reflector and supports the radiator head above the reflector,
wherein the first radiator comprises a balun structure and a shifting structure,
wherein the balun structure comprises a balun ground plane at the support, a signal line at the support, and a connecting line extending from the support to the radiation structures of the radiator head, and
wherein the shifting structure comprises a head portion located on the radiator head and an inductive line electrically connecting the head portion to the balun ground plane.

19. A user device for mobile communication having at least one antenna, wherein an antenna of the at least one antenna comprises a reflector, a first radiator having a radiator head, and at least one support, as well as a second radiator,
wherein the second radiator is mounted to the reflector,
wherein the radiator head of the first radiator comprises at least two radiation structures forming at least one dipole,
the support is mounted to the reflector and supports the radiator head above the reflector,
wherein the first radiator comprises a balun structure and a shifting structure,
wherein the balun structure comprises a balun ground plane at the support, a signal line at the support, and a connecting line extending from the support to the radiation structures of the radiator head, and
wherein the shifting structure comprises a head portion located on the radiator head and an inductive line electrically connecting the head portion to the balun ground plane.
